(19) United States
(12) Patent Application Publication
(10) Pub. No.: US 2006/0015615 A1
(43) Pub. Date: Jan. 19, 2006

(54) Method for data distribution with access control

(76) Inventors: Gilles Merle, Verneuil sur Seine (FR); Denis Piarotas, Antony (FR); Noel Fontaine, Saint Gilles (FR)

Correspondence Address: Thelen Reid & Priest, PO Box 640640, San Jose, CA, 95164-0640, US

(21) Appl. No.: 10/515,031

(22) PCT Filed: May 15, 2003
(86) PCT No.: PCT/FR03/01473

§ 371 Date: Jun. 20, 2005

(30) Foreign Application Priority Data
May 17, 2002 (FR) 02/06086

(51) Int. Cl. G06F 15/173

(52) U.S. Cl. 709/225

(57) ABSTRACT

The present invention relates to a process for distributing digital data to a plurality of user terminals (2) connected to a service provider, via an IP data transmission network (6), each user terminal (2) being identified in the network by an IP address and by a unique address UA entered in a security processor. The process according to the invention consists in associating an access condition defined at HTTP protocol level with the data for distribution.

### TECHNICAL FIELD

The invention is located in the field of access control and relates more particularly to a process for distributing digital data to a plurality of user terminals connected, via an IP data transmission network, to a service provider, each destination terminal being identified in the network by an IP address and by a unique address UA entered in a security processor.

### THE PRIOR ART

French patent application No. 01 13963 filed by France TELECOM on 29 Oct. 2001 describes a process for the distribution with access control of audio-visual programs to a plurality of terminals connected to an IP network.

In this process, each service provided via the network is allocated an address and access conditions defined by the service provider. A scrambling platform receives input IP/UDP datagrams provided in plain language by a data server, and filters the IP/UDP datagrams from the data to be scrambled as a function of the IP addresses and destination ports present in the header of these datagrams.

This solution has a drawback stemming from the fact that the unicast user terminal IP addresses are generally allocated dynamically and also vary from one session to another. As a result, these IP addresses cannot constitute a reliable means for the generation of interchanges with a customer from one session to another.

Additionally, in point-to-point mode another drawback stems from the fact that it is difficult to associate a conditional access (CA) criterion with the content at (ISO 3) network layer level.

The purpose of the invention is to overcome the drawbacks of the prior art described above by a process that allows the access conditions to be defined in point-to-point mode and in distributed mode in correlation, on the one hand, with the user or users requesting the service and, on the other hand, with the distributed content.

### DISCLOSURE OF THE INVENTION

More specifically, the invention makes it possible to define the access conditions, not now at network layer (ISO 3 layer) level, relative to IP parameters, but at presentation layer (ISO 6 layer) level so as to make data distribution independent of address changes.

According to the invention an access condition defined at HTTP protocol level is associated with the distribution data.

In a first alternative implementation of the invention process, the data is distributed in point-to-point mode according to the following steps:
sending, from a user terminal, an HTTP request comprising at least the IP address of said terminal, the unique address UA and a (URI) parameter allowing the data requested to be localised in a content server;
authenticating the sender of the HTTP request by means of the unique UA address,
transmitting the HTTP request to the content server and to a scrambling unit, and on reception of the response to the HTTP request,
associating with each requested data packet an HTTP header comprising the (URI) parameter and an access control field comprising at least one conditional access (CA) criterion previously defined by the service provider;
scrambling the requested data;
transmitting the scrambled data with the conditional access (CA) criterion to the user terminal.

Said conditional access (CA) criterion and said (URI) parameter are previously made available to users by the service provider, for example on a presentation server.

In the first alternative implementation of the invention process, for each user, a customised ECM is generated as a function of the conditional access (CA) criterion and of an encrypted control word CW. The control word CW is encrypted by a key Ke_{UA} obtained by diversification of a root key Ke specific to the service provider. This diversification is executed as a function of the unique address UA specific to each user.

In a second alternative implementation of the invention process, said data is distributed in distributed mode to a group of user terminals identified by a group address. This distribution is carried out in accordance with the following steps:
sending the HTTP request to the central server with the group address;
authenticating the request sender;
verifying that the requested content is distributed, and if the requested content is not distributed;
transmitting a stop message to the user terminal.

In this second alternative implementation of the process, the data is transmitted in PUSH distributed mode, as it is commonly called in English. In this transmission mode, all the users identified by the group address receive the available distributed digital data with no prior obligation to initiate distribution via an HTTP request. Nonetheless, distribution may be controlled by a user, generally the first user, who sends a first HTTP request to receive the service. This user is also able to stop the distribution of data by means of a second HTTP. This is particularly useful when a particular user is making available to a number of other users information over which he has control. This is the case for example with a distance learning application in which a teacher and several listeners are connected to the transmission network, the teacher being the user controlling the distribution (activation and cut-off) of a content.

In the two implementation alternatives, the scrambled data is encapsulated in an IP datagram comprising:
an IP header;
a TCP/UDP header;
an HTTP header; and,
a header containing said access condition.

In one particular embodiment, the security processor is a chip card. However, this processor may be a program stored in the user terminal.

The invention relates also to a management platform for controlling access to scrambled data transmitted to a plurality of user terminals connected to a service provider via an IP network, each user terminal being identified in the network by an IP address and by a unique address UA entered into a security processor, said platform comprising at least one central server able to associate an access criterion with the data for distribution at HTTP protocol level in response to an HTTP request sent from a user terminal.

Preferentially, the data for distribution is susceptible of being extracted as a function of a (URI) parameter from a content server.

The platform according to the invention additionally comprises at least one scrambling unit and at least one content server.

The data for distribution may be audio-visual programs or multimedia data.

### BRIEF DESCRIPTION OF THE DRAWINGS

Other characteristics and advantages of the invention will emerge from the following description, given as a non-restrictive example with reference to the appended figures wherein;

FIG. 1 shows a general diagram of an access management platform according to the invention;

FIG. 2 is a system diagram showing a first alternative implementation of the invention process;

FIG. 3 shows diagrammatically the mode for encapsulating the distributed data by the process according to the invention;

FIG. 4 is an organisation chart showing the first alternative implementation of the invention process,

FIG. 5 shows diagrammatically a procedure for diversifying the access control messages according to the invention;

FIG. 6 shows diagrammatically the diversification of an ECM in point-to-point mode;

FIG. 7 is a system diagram showing a second alternative implementation of the invention process.

### DETAILED DISCLOSURE OF PARTICULAR EMBODIMENTS

The invention will be described in the context of a particular application in which the data for distribution is audio-visual programs transmitted to several users through the Internet network. Each user is equipped with a terminal 2 fitted with a chip card reader. Each user has a personal chip card identified by a Unique Address UA containing information about the rights of access to audio-visual services provided by one or more operators.

In a particular embodiment, each user terminal may be a gateway terminal communicating with a plurality of terminals grouped into a local network. In this case, it is the gateway terminal which is fitted with a chip card containing at least one right of access to the services provided.

The audio-visual contents are stored in remote servers and each content is susceptible of being called upon by a Uniform Resource Indicator (URI) which is a field of the HTTP header allowing a resource to be addressed in a unique way.

In the remainder of the description we shall denote by the term Viaccess Net® platform all the equipment intended to process audio-visual flows prior to their transmission to users.

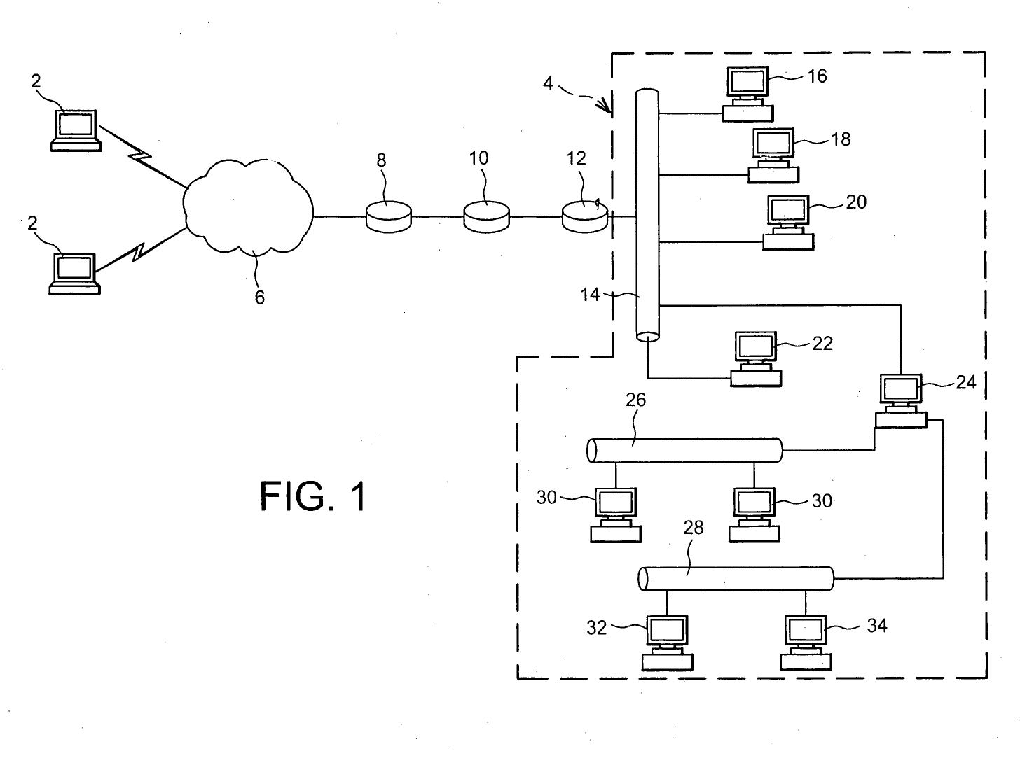

With reference to FIG. 1, user terminals 2 are connected to the Viaccess Net® platform 4, through the Internet network 6 or through an IP trunking. A first output router 8 is provided at the output of the Internet network 6 and is connected to a second interconnection router 10 which is connected to a Firewall server 12 connected directly to the Viaccess Net® platform 4.

The Viaccess Net® platform 4 comprises a first local access network 14 comprising a central server 16 the function of which is to supervise communications between the user terminals 2 and the platform 4.

The first local network 14 additionally comprises a cache server 18 intended to store information that does not need to be scrambled such as service presentation pages for example, a DNS server 20 intended to express as names the IP addresses of servers that are internal or external to the Viaccess Net® platform 4 and a second security server 22 intended to provide a functional redundancy of the central server 16. This first local access network 14 is connected, via a scrambling station 24, to a second local network 26 and to a third local network 28. The second local network comprises content servers 30 and the third local network 28 comprises an ECM generator 32 and an ECM management station 34.

Point-to-Point Mode

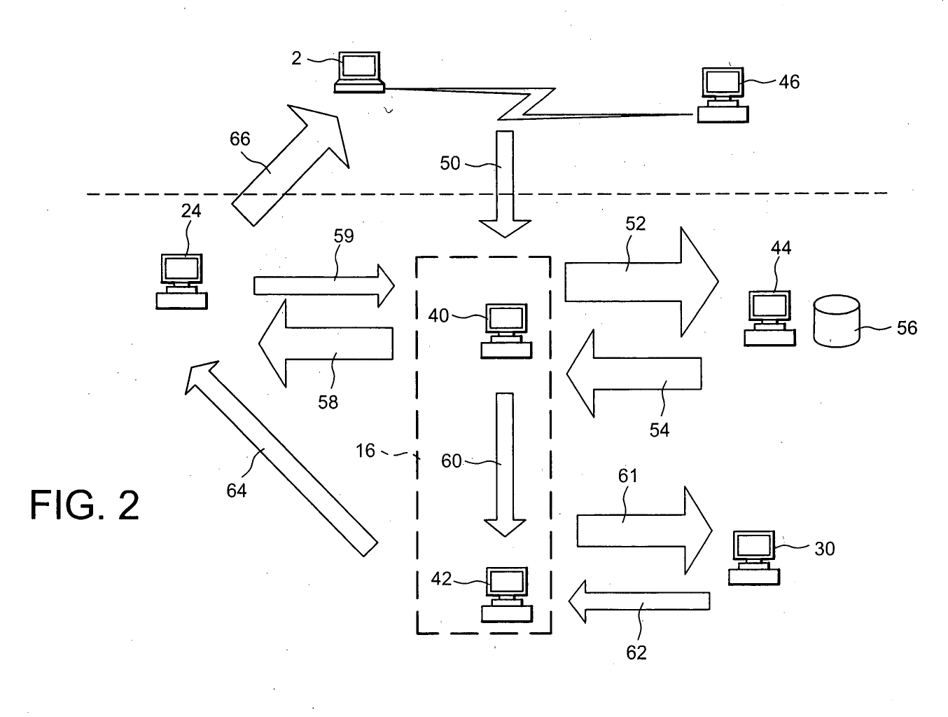

Operating in point-to-point mode will be described with reference to FIG. 2 in which only the elements essential to the process implementation are shown. In this FIG. 2, the central server 16 is constituted by two separate functional units, a first unit 40 dedicated to user authentication and to filtering the HTTP requests transmitted to the platform 4, and a second unit 42 able to associate a (CA) control criterion with the data for distribution. User authentication consists in verifying whether the UA received with the HTTP request is listed in a right management centre 44 located with the operator.

Prior to this, the user wishing to receive one or more audio-visual programs receives from the operator information relating to the (CA) criteria for accessing audio-visual programs susceptible of being requested.

After interrogating a presentation server 46, the user sends (arrow 50) to the central server 16 an HTTP GET request giving his unique address UA, his IP address and the URI corresponding to the programs requested. The authentication unit 40 filters the HTTP request by means of the unique address UA and carries out the following actions:
controlling the flow at encrypted datagram transport level. In particular, this unit 40 checks that the TCP feedback packets are received within the maximum transit delay between the platform 4 and the customer-terminal 2;
controlling the session following the previous control. Indeed, the session may be interrupted if the maximum transit delay is exceeded.

The central server 16 then sends (arrow 52) to the operator management centre 44 the IP address of the terminal 2 for the return path, the UA address of the user and the URI called upon as well as the IP address from which the data is to be sent and which is retrieved by the user from the presentation server 46.

The management centre 44 gives its agreement or refuses access (arrow 54) to the content as a function of the rights pre-recorded in a database 56.

The UA address, the URI and the IP address of the user terminal are then sent by the central server 16 (arrow 58) to the scrambling unit 24 by means of an HTTP request. The conditional access (CA) criterion associated with the content is also sent by this means. All these parameters will allow the scrambling unit 24 to identify the response to the HTTP request which will come from the content server 30 via the central server 16.

The scrambling unit 24 sends an acknowledgement (arrow 59) to the authentication unit 40 confirming that it is expecting from the content server 30 the flow for scrambling selected by the user with the associated UA and IP address and the conditional access (CA) criterion.

The HTTP GET request is then retransmitted via the authentication unit 40 (arrow 60) to the unit 42. The latter takes the request into account by noting the URI and sends back (arrow 61) this same HTTP GET request to the content server 30.

The response to the HTTP GET request transmitted from the content server 30 to the central server 16 is then sent back (arrow 62) to the unit 42. The latter inserts a supplementary field into the IP frame consisting of an HTTP header with a “Content Location” field which will remind the scrambling unit 24 of the URI. The central server 16 sends (arrow 64) the HTTP response to the scrambling unit 24 for scrambling.

The scrambling unit 24 scrambles the data and transmits it (arrow 66) to the user terminal 2 which unscrambles it by means of the transmitted control information and the rights entered in the chip card.

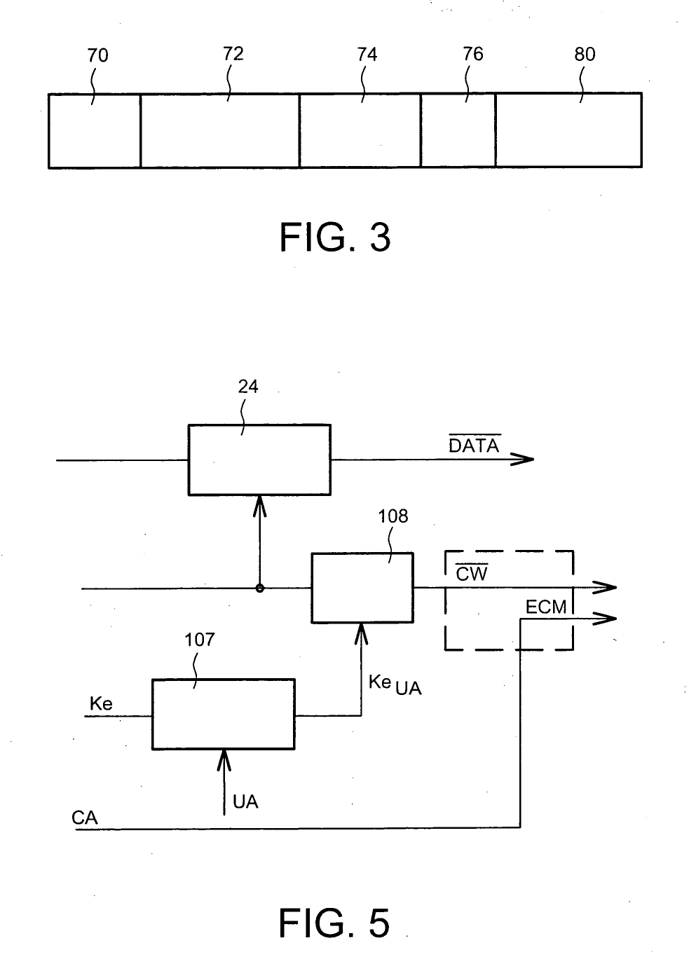

FIG. 3 shows diagrammatically the structure of the packets transmitted to the scrambling unit 24 by the central server 16. This HTTP response comprises:
an IP header 70;
a TCP/UDP header 72;
an HTTP header 74;
an access control header 76 containing the URI of the data delivered and
the scrambled data 80.

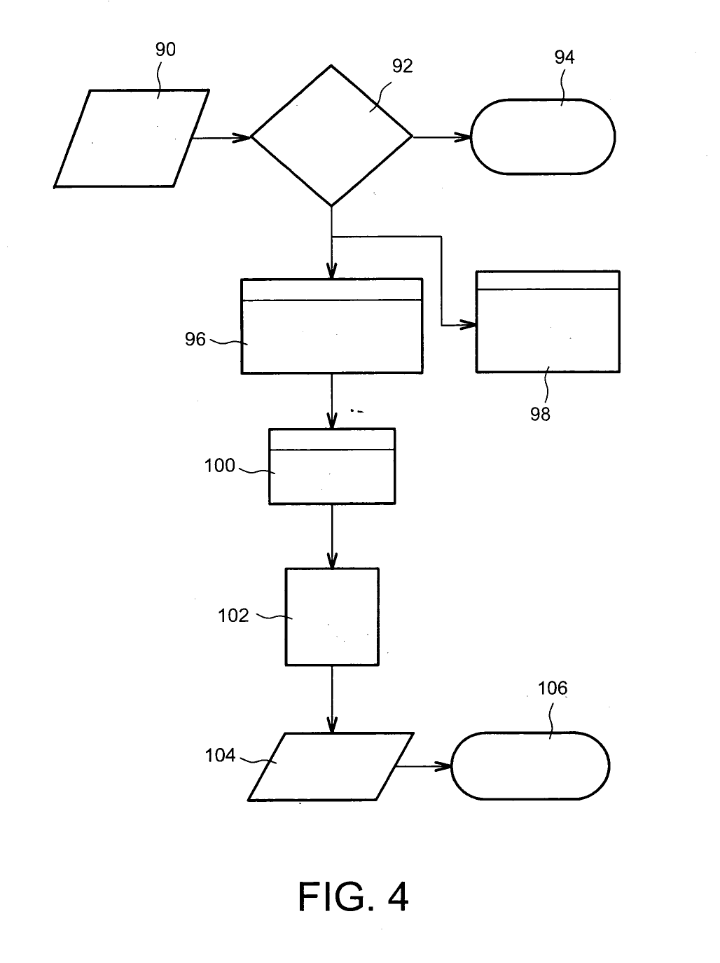

The organisation chart in FIG. 4 shows in detail the different steps in the process in the case of an implementation in point-to-point mode.

At step 90 the user sends the HTTP GET request asking for content to the central server 16 via a secure link by encrypted tunnel between the user terminal 2 and the Viaccess Net® platform 4.

This secure tunnel is specific to each link with a terminal 2 and can be based on the Secure Socket Layer (SSL) protocol, or the Secure Shell (SSH) protocol, or again on the IPSec protocol. Security makes it possible to increase the integrity and confidentiality of the data flowing on the Internet network between the terminal 2 and the Viaccess Net® platform 4.

At step 92, the central server 16 retrieves the URI of the requested content and verifies the validity of the GET request.

If this request is not valid, the flow is refused to the user (step 94).

If the GET request is valid, the central server 16 transmits it to the scrambling station 24 and to the content server 30 (step 96).

In the same way, the central server 16 establishes a link between the terminal 2 and the cache server 18 so as to allow it to interrogate data which is not to be scrambled such as service presentation pages for example (step 98).

In response to the GET request, the content server 30 delivers the requested data to the scrambling unit 24 via the central server 16. The latter adds to each packet of data delivered by the content server 30 the “Content Location” field containing the URI and sends this packet back to the scrambling unit 24 where the data is scrambled with the HTTP header added (step 100).

At step 102, the central server 16 deletes the location header field of the HTTP header and delivers the encrypted flow to the terminal 2 (step 104) via the secure channel between Viaccess Net® platform 4 and the terminal 2.

At step 106, the scrambled data is received by the user terminal 2 where it is unscrambled.

According to one characteristic specific to the point-to-point mode, for access to one and the same program, a customised ECM, known as an ECM-U, carrying the access conditions and a root encryption key Ke of this program is generated as a function of the conditional access (CA) criterion and of an encrypted control word CW.

The control word CW is encrypted by a key Ke_{UA} obtained by diversification of the root key Ke specific to the server provider. This diversification is executed as a function of the unique address UA specific to each user.

In this way, the program requested is only able to be seen by the user whose card is targeted by the ECM-U and contains at least one right in accordance with the conditional access (CA) criterion described in the ECM-U.

FIG. 5 shows diagrammatically the diversification procedure for the root key Ke. The latter is subject to processing in a calculation module 107 which receives the input unique address UA of each user. The result of this calculation is the diversified key Ke_{UA} that depends on the user's unique address UA. The key Ke_{UA} is then used to encrypt the control word CW. This function is implemented by a module 108 which receives the Ke_{UA} and CW value.

Prior to this, the user is registered as the potential addressee of information that is strictly personal in nature, or of a restricted group controlled by the operator. This control relates to the identity of each potential receiver by means of the unique address UA.

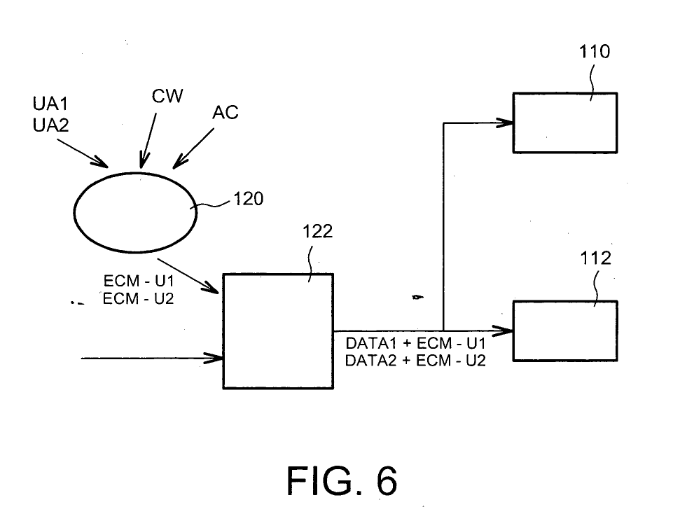

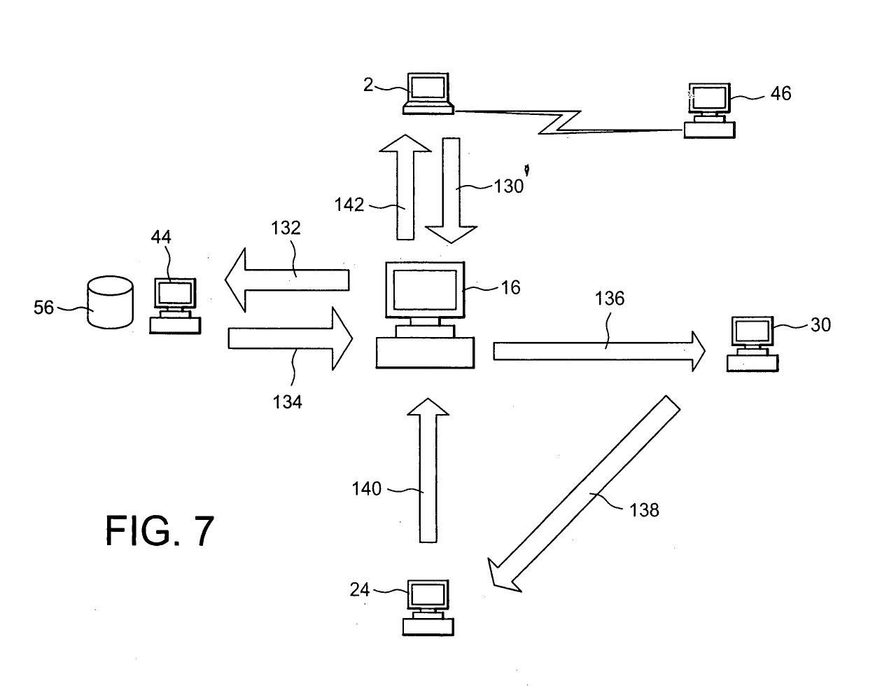

FIG. 6 shows this principle diagrammatically in the case where two terminals 110 and 112 with the unique address UA1 and UA2 respectively send an HTTP request to the platform 4 to receive a program. The ECMs are customised by the control word CW encrypted by the diversified key Ke_{UA} in order to generate, by means of a calculation function 120, an ECM-U1 and an ECM-U2 intended for terminal UA1 and terminal UA2 respectively. The ECM-U1 and ECM-U2 are then multiplexed by a multiplexing module 132 then transmitted to the users.

Distributed Mode

In this mode of implementation shown in FIG. 7, distribution is made to all the terminals parameterised by a group address. In this case, the user sends (arrow 130) the HTTP request to the central server 16 with the group address. The latter authenticates (arrows 132-134) the sender of the request, and verifies (arrow 136) whether the requested content is actually distributed. If the requested content is not distributed, the central server 16 transmits a stop message to the user terminal.

If the content is distributed, the authenticated user receives the distributed content.

To sum up, this implementation mode comprises the following steps:
the user makes a request: the IP address of the terminal for the return path, the group IP address, the UA and URI called upon are noted by the central server 16;
the management centre 44 gives its agreement or refuses the content access session after transferring all the previously entered parameters;
the response may be positive for distribution, in which case the content server delivers the requested data (step 138) to the scrambling unit 24 which transmits this data (step 140) after scrambling. The response can also be negative, in which case data distribution is refused. It should be noted that in this implementation mode, it is possible for a user not to be able to have the right to initiate distribution of a content;
the group IP address and the URI are sent with an initiate distribution of content command generated by the central server 16;
the requested flow is distributed and the IP source address for the distribution is that of the content server 30;
the response is lastly sent back to the terminal (step 142) which unscrambles the content received using previously installed decoding software.
   Applications

The process of the invention may be implemented in a service access control system with content marketing via the HTTP protocol. This content may comprise images on a HTML page subject to access conditions or again a text portion.

This system may allow servers to be implemented that deliver contents which are scrambled so as to market downloading of videos, audio (music, etc) files, etc.

By way of example, the invention may be implemented in the fields of the following PC applications:
“Content On Demand”—a content on demand offer such as on-line share dealing or banking, television, video or radio clips,
customised message handling system,
file downloading (games, virtual reality software, other application or personal productivity (training, etc.) software.

The invention may also be applied to business sectors requiring the use of the Internet network to distribute Unicast data (filmed meetings, video-conferencing on a VPN network, access to highly confidential documentation, etc).

The invention also finds applications in the sectors of cable operators and digital TV satellite operators. IP service operators may implement the distribution of scrambled contents that are susceptible of being interrogated following previous purchase. Intranet interrogations requiring heavy scrambling, associated with read/write rights management over a content to be downloaded by an IP network may constitute additional applications of the invention.

The invention may also be implemented in order to control access to a content received via a receiver fitted with a TV decoder.

Lastly, the invention may be implemented in mobile telephony or satellite telephony applications. The transport technologies targeted are interactive GSM, GPRS or UMTS applications.

It is also possible to implement the invention in order to receive scrambled audio-visual programs on a mobile telephone or a PDA.

1. Process for distributing digital data to a plurality of user terminals (2) connected to a service provider via an IP data transmission network (6), each destination terminal (2) being identified in the network by an IP address and by a unique address UA entered in a security processor, a process characterised in that the data is associated with an access condition defined at HTTP protocol level.

2. Process according to claim 1, characterised in that the data is distributed in point-to-point mode according to the following steps:
sending, from a user terminal (2), an HTTP request comprising at least the IP address of said terminal (2), the unique address UA and a (URI) parameter allowing the data requested to be localised in a content server (30);
authenticating the sender of the HTTP request by means of the unique UA address,
transmitting the HTTP request to the content server (30) and to a scrambling unit (24),
on reception of the response to the HTTP request, associating with each requested data packet an HTTP header comprising the (URI) parameter (74) and an access control field (76) comprising at least one conditional access (CA) criterion previously defined by the service provider;
scrambling the requested data;
transmitting the scrambled data with the conditional access (CA) criterion to the user terminal (2).

3. Process according to claim 2, characterised in that said conditional access (CA) criterion and said (URI) parameter are previously transmitted to the users (2) by the service provider.

4. Process according to claim 3, characterised in that, for each user, a customised ECM is generated as a function of the conditional access (CA) criterion and a control word CW encrypted by a key Ke_{UA} obtained by diversification of a root key Ke as a function of the unique address UA of each user terminal (2).

5. Process according to claim 1, characterised in that said data is distributed in distributed mode to a group of user terminals (2) identified by a group address in accordance with the following steps
sending the HTTP request to the central server (16) with the group address;
authenticating the sender of the HTTP request;
verifying that the requested content is distributed if the requested content is not distributed;
transmitting a stop message to the user terminal (2).

6. Process according to claim 5, characterised in that the data distribution is controlled by a user.

7. Process according to claim 1, characterised in that said scrambled data is encapsulated in an IP datagram additionally comprising:
an IP header (70);
a TCP/UDP header (72);
an HTTP header (74);
an access control header (76) containing said conditional access (CA) criterion.

8. Process according to claim 1, characterised in that the security processor is a chip card.

9. Process according to claim 8, characterised in that each user terminal (2) is a gateway terminal communicating with a plurality of terminals grouped into a local network.

10. Management platform (4) for controlling access to scrambled data transmitted to a plurality of user terminals (2) connected to a service provider via an IP network (6), each user terminal (2) being identified in the network (6) by an IP address and by a unique address UA entered in a security processor, a platform characterised in that it comprises at least one central server (16) able to associate a conditional access (CA) criterion with the data for distribution at HTTP protocol level in response to an HTTP request sent from a user terminal (2).

11. Platform according to claim 10, characterised in that the data for distribution is susceptible of being extracted as a function of a (URI) parameter from a content server (30).

12. Platform according to 11 claim 8, characterised in that it additionally comprises at least one scrambling unit (24) and at least one content server (30).

13. Platform according to claim 8, characterised in that the data for distribution is audio-visual programs.

14. Platform according to claim 8, characterised in that the data for distribution is multimedia data.
